(19) United States
(12) Patent Application Publication
(10) Pub. No.: US 2002/0135142 A1
(43) Pub. Date: Sep. 26, 2002

(54) Scooter

(76) Inventor: Michael D. Hinds, Freeport, NY (US)

Correspondence Address: Wyatt, Gerber & O'Rourke, 99 Park Avenue, New York, NY, 10016, US

(21) Appl. No.: 09/817,001

(22) Filed: Mar. 26, 2001

(51) Int. Cl. B62B 13/18

(52) U.S. Cl. 280/9; 280/87.041

(57) ABSTRACT

An improved scooter is disclosed that permits the user to use the vehicle on a variety of surfaces including snow and ice. The scooter has a base having a front wheel and a rear wheel that are rotatably connected to the base. The base has a steering means extending upwardly from the base and adapted to steer the front wheel. The base has an upper surface and a bottom surface, the lower surface has an attachment means for connecting a ski to the base said ski being comprised of a flat bottom surface and a front end and a rear end said ski having at said front end a lip to facilitate travel over snow. Alternatively, a runner having a blade may be connected in place of the ski to permit the scooter to ride on ice.

### FIELD OF THE INVENTION

The present invention relates to the field of scooters and related vehicles.

### BACKGROUND OF THE INVENTION

In the past few years, there has been a resurgence of interest in scooters. Wheeled vehicles that are typically propelled by the foot motion of the user are well known in the art. Besides bicycles that are propelled by pedaling there are also vehicles propelled by the motion of a foot on the traveling surface. These vehicles are usually called scooters and have one or more front wheels and one or more rear wheels. The front wheel or wheels rotate about an axle as does the rear wheel or wheels. The axles are connected to a frame which usually has a rest area for one or both of the user's feet. Extending from the frame is a raised member or stem that ends in a handle bar that provides a place for the user to place his hands during use of the vehicle. The rest area for the hands may also permit the scooter to be steered by the user. Many of the modern scooters are provided with a break means for stopping the rear wheel as necessary by the user. Although it is possible for a braking means to be present on the front wheel of the scooter this arrangement frequently raises a safety issue. When the front wheel of a scooter is stopped during motion, the continued forward motion of the scooter is transferred into a force that causes the rear of the scooter to be lifted off of the traveling surface and forcing the rider downwardly toward the ground, thereby increasing the risk of injury to the rider.

One of the problems with the prior art scooters has been the ability of the owner to use the scooter during the entire year and on different surfaces. Since scooters are wheeled vehicles, the typical scooter is difficult to use during the winter months when there is snow or ice on the ground. The presence of snow on the ground makes it difficult to rotate the tires by the user's foot action to propel the scooter any great distance. the friction of the snow on the wheels makes it very difficult for the user to travel for any distance due to the momentum of the foot motion. The snow prevents the scooter from rolling any along on its own after it has been propelled with the rider. Similarly, when there is ice on the riding surface, the wheels frequently lack traction and there is a risk that they will slide on the ice and it will be difficult to control the scooter.

Accordingly, there is a need for an improved scooter that will permit the user to use the scooter on a variety of surfaces including snow and ice. There is also a need for a scooter that is capable of being used during the entire year and not just the relatively warm weather months.

### OBJECTS OF THE INVENTION

It is an object of the invention to provide an improved scooter with in creased versatility for use on a variety of surfaces.

It is another object of the invention to provide a scooter that is capable of being used on snow.

It is also an object of the present invention to provide a scooter that may be used on icy surfaces.

It is still another object of the present invention to provide a scooter with modular attachments that permit the scooter to be readily transformed from solely a wheeled vehicle to one that has runners to permit it to be used on icy surfaces.

It is a further object of the present invention to provide a scooter with a modular attachment to permit the scooter to be readily transformed from solely a wheeled vehicle to one that has one or more ski type attachments for use on snowy surfaces.

### SUMMARY OF THE INVENTION

The present invention is directed to a scooter which is in the form of a vehicle having at least one or more front wheels that rotate about an axle. There are also one or more rear wheels that rotate about a separate axle. The axles for the wheels are attached to the underside or the sides of a base or stand which has on its top surface an area for the rider to rest one or both feet as desired. The base has a front end and a read end. Rising from the front end is a stem that may have be have a hand rest on its upper surface. In a preferred embodiment, the stem is connected to the front axle to permit the hand rests to steer the scooter during use.

The scooter of the present invention is provided with an means for connecting one or more skis to the underside of the scooter to permit the scooter to be used on snowy surfaces. The skis have a smooth underside and may be attached to the scooter base by a variety of means. In a preferred embodiment, the ski is provided on its upper surface with a member that extends upwardly from the upper surface and may be inserted into an orifice on the underside of the scooter where it may be locked on place by a bayonet type connection or a pin that passes through the side wall of the orifice and through the upwardly extending member or by another suitable connecting means. Preferably, the ski has two upwardly extending members for additional support and stability. Alternatively, there may be two skis that are attached to the underside of the scooter base. Alternatively, the skis may be attached to the side walls of the scooter base.

One of the advantages of the present invention is the ability to use the scooter not only on snow but also on ice. Accordingly, the scooter may be provided with a single runner extending from the underside of the base. The runner is preferably a metal runner with a sharp blade for ease of use on ice. The runner may be attached to the underside of the base in the same manner as the ski. Similarly, if desired, there may be two runners on the scooter for additional stability and ease of use.

The scooter of the present invention may be propelled by foot power, i.e., the force of the user's foot pushing off the ground causing the scooter to be propelled. In addition, the scooter may be motorized by the addition of a motor to drive one or both of the wheels on the axles. Similarly, if desired there may be a seat means on the rear of the scooter to permit the user to rest while the scooter is coasting or being driven by the motor.

### BRIEF DESCRIPTION OF THE DRAWINGS

FIG. 1 is a side view of the scooter of the present invention.

FIG. 2 is a side view of the scooter of the present invention with a ski attached.

FIG. 2A is an example of an connecting means for securing an attachment to the scooter.

FIG. 3 is a front view of the scooter of the present invention with a pair of skis attached.

FIG. 4 is a side view of the scooter of the present invention with a runner attached.

FIG. 5 is a front view of the scooter of the present invention with a pair of runners attached.

FIG. 6 is a side view of the scooter of the present invention with a seat present.

FIG. 7 is a view of an example of the attachment of the ski to underside of the scooter.

FIG. 8 is a view of an example of the attachment of a pair of skis to underside of the scooter.

FIG. 9 is a view of an example of the attachment of a runner to the scooter base.

FIG. 10 is a view of an example of the attachment of a pair of runners to the underside of the scooter base.

FIG. 11 is a view of the scooter in a folded condition.

FIG. 12 is a perspective view of the scooter.

FIG. 13 is an example of the modularity of the ski and blade.

FIG. 13A shows the slot in the upper surface of the ski.

FIG. 14 is another embodiment of the scooter of the present invention.

FIG. 15 is an alternate embodiment of the scooter of FIG. 14.

FIG. 16 shows the wheel assembly of one embodiment of the scooter of the present invention.

FIG. 17 shows a ski assembly to replace the wheel assembly of FIG. 16.

FIG. 18 shows a blade assembly for traveling on ice to replace the wheel assembly of FIG. 16.

FIG. 19 shows a ski attachment that may be placed on either side of the scooter wheel.

FIG. 20 shows a blade attachment that may be placed on either side of the scooter wheel.

### DETAILED DESCRIPTION OF THE PREFERRED EMBODIMENTS

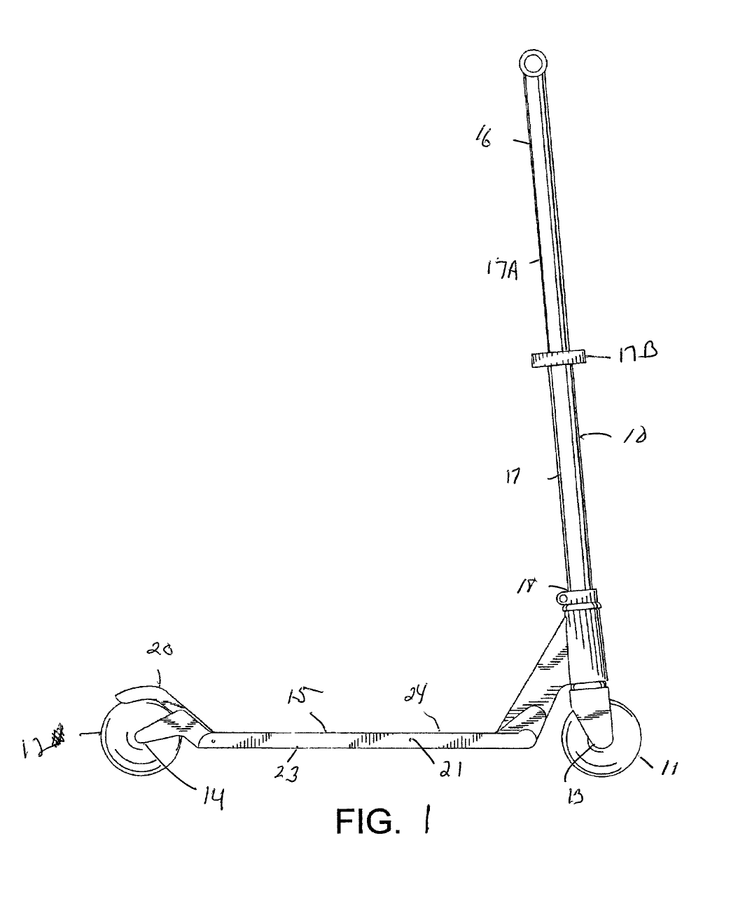

As seen in FIG. 1 there is a scooter 10 having a front wheel 11 and a rear wheel 12 that rotate about axles 13 and 14. The scooter may have a single wheel in the front on the axle or more than one wheel. Similarly, there may be a single wheel in the rear on the axle or more than one wheel. The scooter has a base 15 which provides an area for the user to place one or both of his feet. Preferably attached to the front axle is a steering means 16 which may be in the form of a rod 17 that passes through an orifice 18 in the base 15. The rod 17 may be generally hollow inside and have a second rod 17 that telescopes inside the first rod to be able to adjust the height of the steering means. A nut 17B may be used to tighten the connection between the first and second rods when the preferred height is reached. The rod 17 is connected to the axle so that as the rod is rotated by handles 19 and 19A the direction of the front wheel changes. Instead of handles the scooter may be steered by a steering wheel, not shown. The handles may be provided with a soft flexible material to improve the comfort of the user.

The base 15 of the scooter may preferably have a braking means 20 attached in the area of the rear wheel that contacts the rear wheel 12 and causes the wheel to stop rotating due to friction pressure on the wheel or wheels. In an alternative embodiment the braking means may apply a force to the traveling surface where friction on the traveling surface causes the scooter to stop.

The scooter may be made of any suitable material, however, it is preferably made of a strong lightweight metal such as aluminum that will not suffer from corrosion readily. Alternatively, the scooter or parts thereof may be made of a plastic material such as a polyethylene, a polypropylene, ABS plastic or other suitable material. The base of the scooter is preferable provided with an edge 21 that extends downwardly from the base. This edge or skirt provides some stiffening for the base to prevent unnecessary flexing thereby increasing its strength. The top surface 24 of the scooter base 15 is preferably provided with a roughened surface that provides some traction to the riders foot to prevent the feet from sliding off the scooter during use particularly in damp weather. The wheels and axle can also be provided with a shock absorbing mechanism for the wheel of the type wheel known in the art. The shock absorbing mechanism will provide a smoother ride for the user particularly over rough or uneven surfaces.

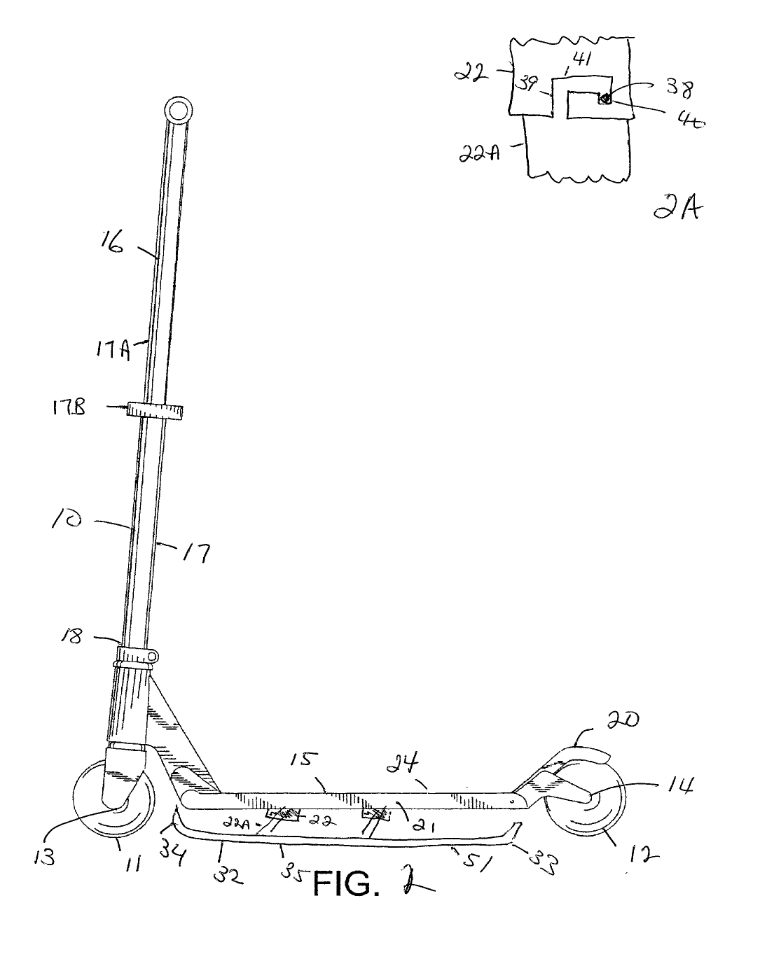

The underside of the scooter may be provided with one or more attachment means for connecting a variety of components to the scooter to increase its versatility. As seen in FIG. 2, the underside of the scooter base may be provided with one or more members 22 that extend downwardly from the underside 23 of the base 15. The member 22 can for example be tubular and generally hollow on its inner surface and adapted to receive a member 22A extending upwardly from an attachment such as a ski 51 or a runner 52 as shown in FIGS. 2. As seen in FIG. 2 the ski has a flat surface 31 that has a front end 32 and a rear end 33. The front end 32 is preferably provided with a lip 34 to permit the ski to ride over the snow that may be encountered by the scooter. The underside surface 35 of the ski is preferably relatively smooth to permit the ski to glide easily over the snow. The upper surface 36 of the ski may be provided with an upwardly extending leg. The leg 22A may be in the form of a rod or tubular member. The tubular member 22 may be provided with a dimple or recess on the inner surface of the tubular member 22 to receive a projection 38 on leg 22A that mates therewith to lock the ski in place on the scooter. Alternatively, the tubular member 22 may be provided with a slot 39 that extends upwardly for a small distance from the edge of the tubular member. The slot has second length 41 that is at generally a right angle to second length with a locking section 40 extending downwardly therefrom. A spring (not shown) is preferably present in the tubular member 22 which places a force on the tubular leg 22A to hold it in position in the locking section 40. (See FIG. 2A)

In an alternate embodiment, the Tubular leg 22A may be provided with the slot 39 and the tubular member 22 may have the dimple 38, if desired. Alternatively, the attachments may be secured to the scooter by any other suitable means such as by a screw or bolt extending through the base into the member extending upwardly from the attachment. Although the member has been described as being tubular any cross section is possible including square, rectangular, ovoid etc.

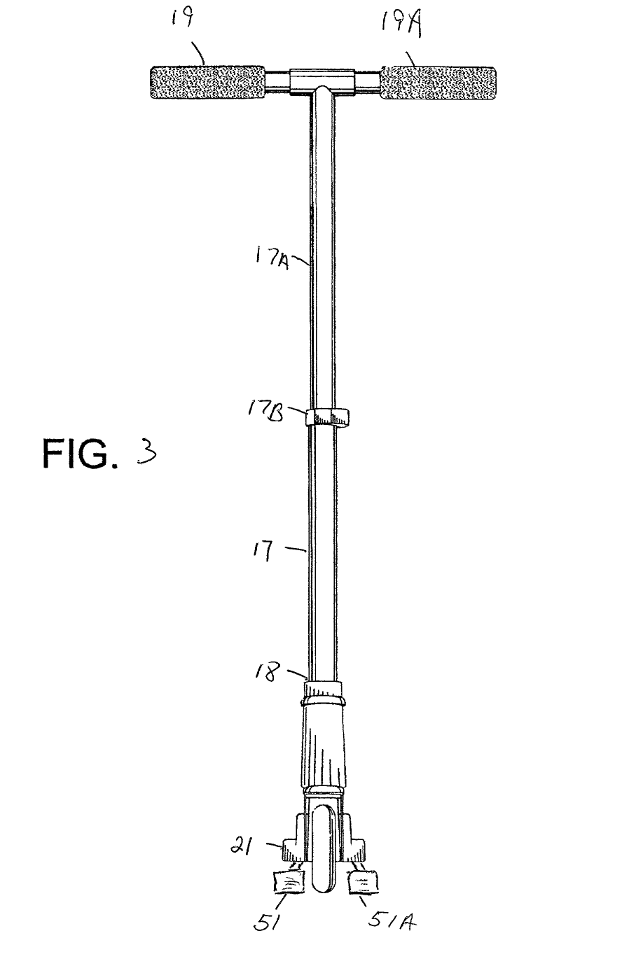

The scooter may be provided with one ski 51 or if desired may be provided with a second ski 51A as shown in FIGS. 3 and 8. If the scooter is provided with a second ski, the legs may extend outwardly at an angle to provide additional support for the scooter or the legs may be generally straight down. As can be seen from the FIG. 2, the bottom surface of the ski may be in generally the same plane as the bottom of each of the wheels. However, the ski can be in a plane either lower or higher than the plane of the bottom surface of the wheel when the scooter does not have a load thereon.

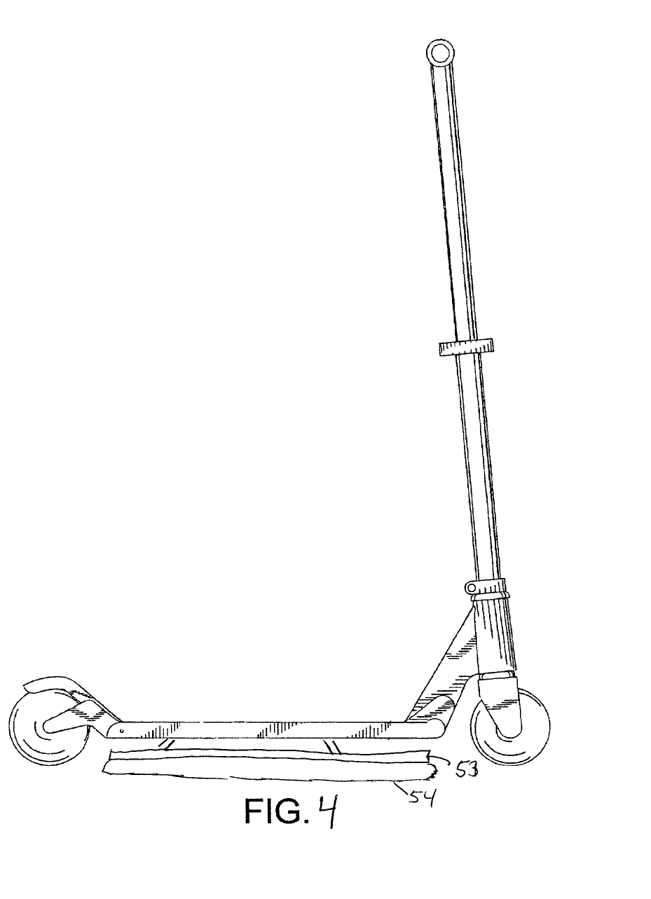

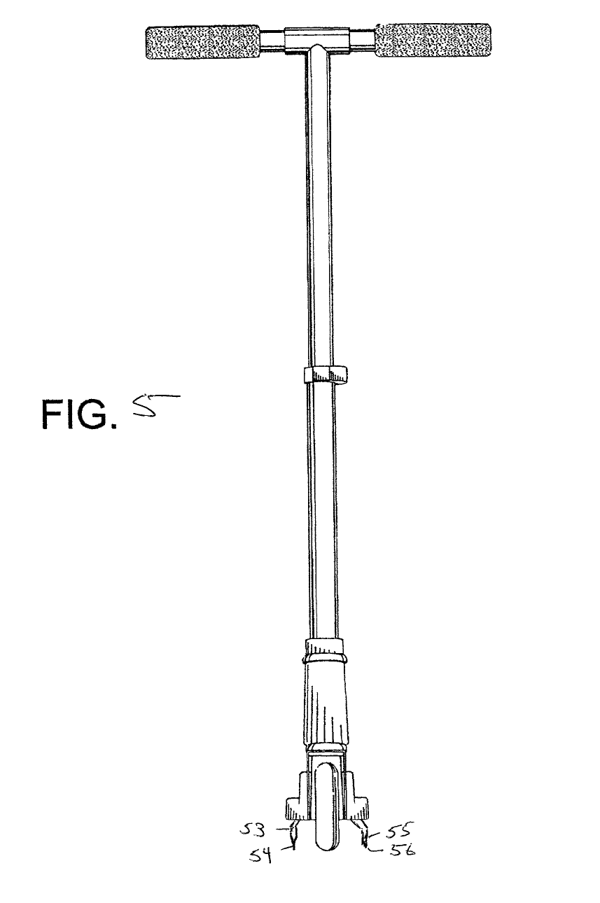

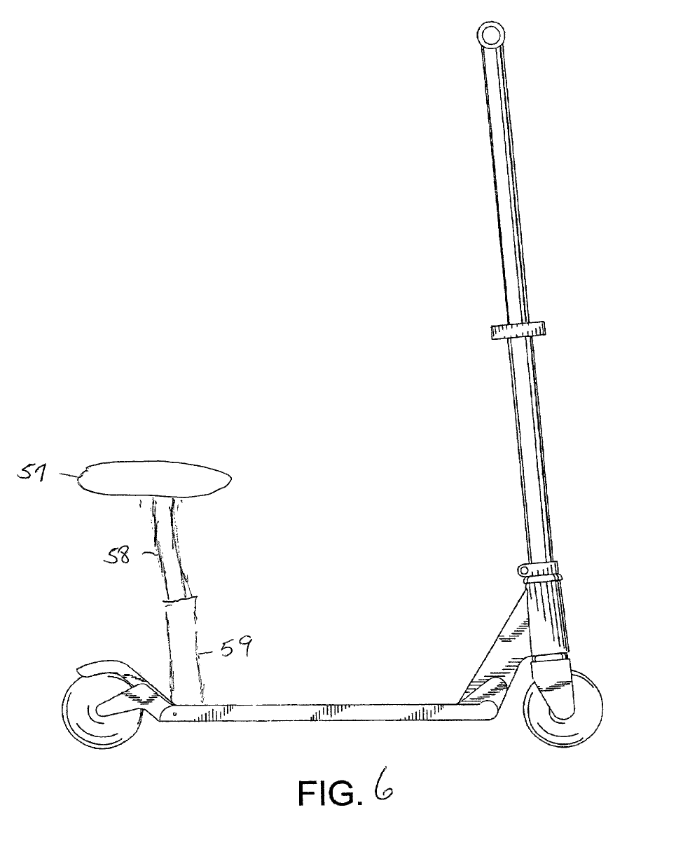

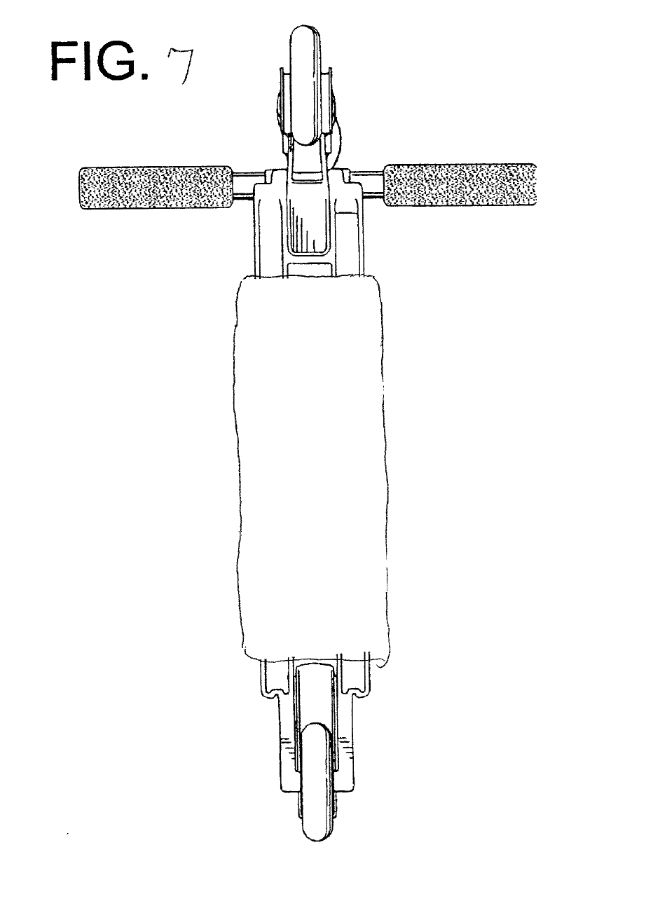

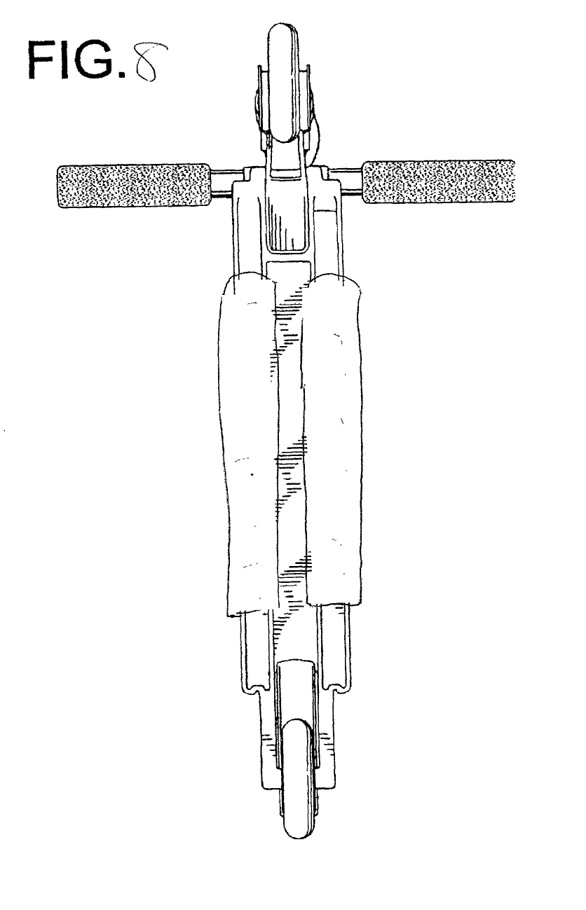

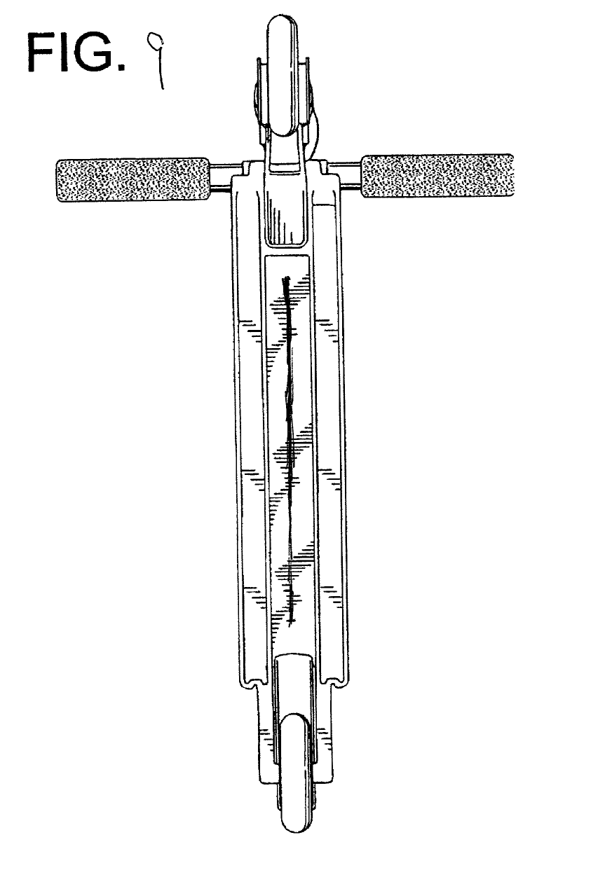

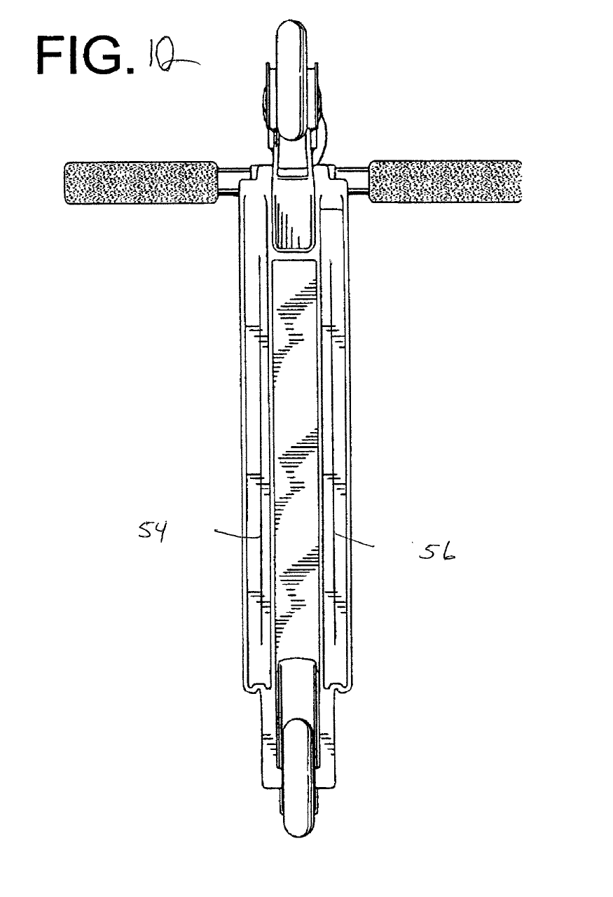

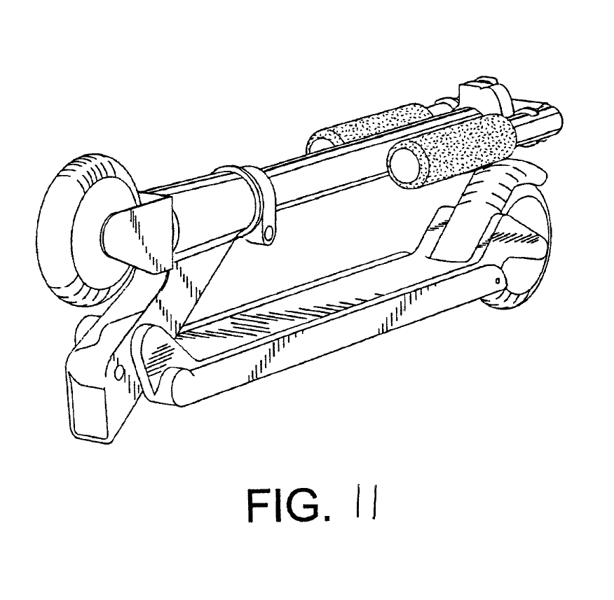

As seen in FIG. 4 the scooter of the present invention may be provided with a runner 53 instead of a ski. This runner may be attached to the underside of the scooter in the same manner as the ski. This runner should preferably have a thin blade 54 that permits the scooter to travel on ice. Preferably, the blade is made from a hardened steel usually a stainless steel to prevent corrosion,. Alternatively, the blade may be made of a hardened plastic. The blade preferably has a thin cross section to make it easier for the blade to travel along the icy surfaces. There may be a single blade or if desired the underside of the scooter may be provided with a second runner 55 and blade 56 as seen in FIG. 5. To add to the user's comfort, the scooter may be provided with a removable seat 57. may have a stem 58 extending from the underside of the seat. The stem may be inserted into an upwardly extending member 59. The seat may be raised and lowered as desired and there is a suitable tightening means lock the seat in position once the desired height has been reached. The member may be screwed or bolted into an orifice in the surface of the base by any suitable means. The seat may be provided with a cushion on its upper surface to improve the user's comfort. The steering rods may also be designed to fold downwardly toward the base of the scooter for storage as shown in FIG. 11. In an alternative embodiment. the scooter may be provided with a motor, either electric or otherwise to provide a driving force.

One of the key features of the present invention is the modularity of the attachments whereby the skis can be readily replaced by the runners as conditions or the users desires warrant. The user can readily add one attachment to the scooter to permit the user to travel on snow and this attachment can be readily removed to permit a second attachment to be installed to facilitate travel over ice. In one embodiment, the runner 81 and blade 82 may be attached to the scooter as discussed above and the ski attachment 83 may be attached to the blade of the runner. This may be accomplished by providing the upper surface of the ski with a slot 84 in a raised member 85 that will receive the blade of the runner. The ski and the blade may be connected together by any suitable means such as by one or more bolts that pass through corresponding orifices in the ski member and the blade or runner.

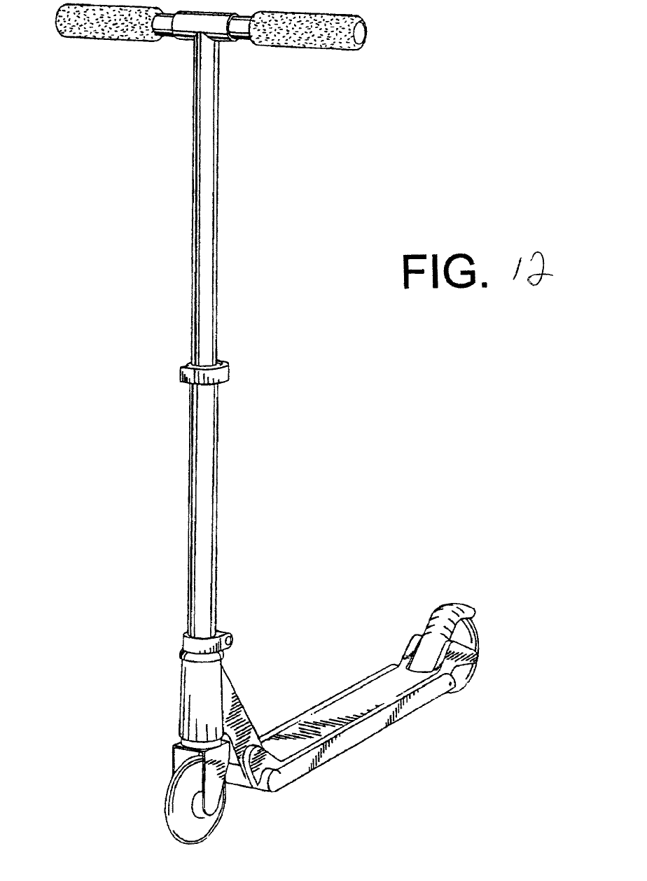

In an alternate embodiment shown in FIG. 14, the scooter has a frame 100 with one or more front wheels 101 and one or more rear wheels 102. The wheels rotate about an axle 103 and 104 respectively. The axles are preferably connected to a fork 105 having tine 106 and 107, The axle may be held in place on the tines by any suitable means. such a a threaded nut or a cap. The frame has a front support 108 that is connected to the fork 105. The fork 105 and the front support may be a single member or they may be two members. In one embodiment, the fork may be open at its end 109 and adapted to receive the front member in the opening. The two may be connected by any suitable means known in the art. Alternatively, the end 109 of the fork may be received in an opening in the front support 108. At the end of the front support 108 opposite the fork 108 the front member is adapted to receive a stem 110. The stem may have conventional handle bars extending therefrom. The front support 108 is preferably retained in the frame 100 by for example sleeve 111. The front support 108 is adapted to rotate in at least an arc to permit the wheel to be steered by the handle bars or other steering means. Extending from the sleeve 111 may be one or more frame members 112 and 113 that provide rigidity to the frame 100. The frame 100 may also be provided with a seat 114 that is preferably adjustable in height. The seat may have a stem 115 that passes into an orifice in the frame and the stem may be retained therein by a nut or other suitable means.

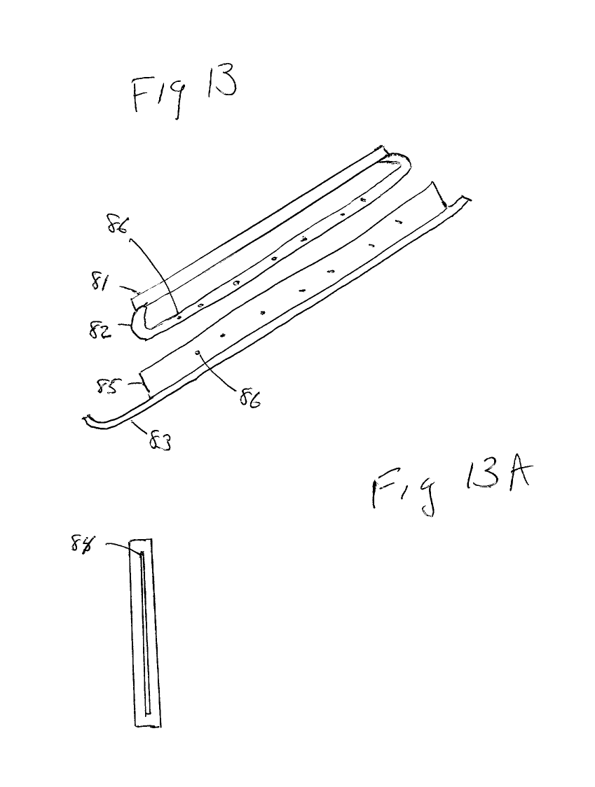

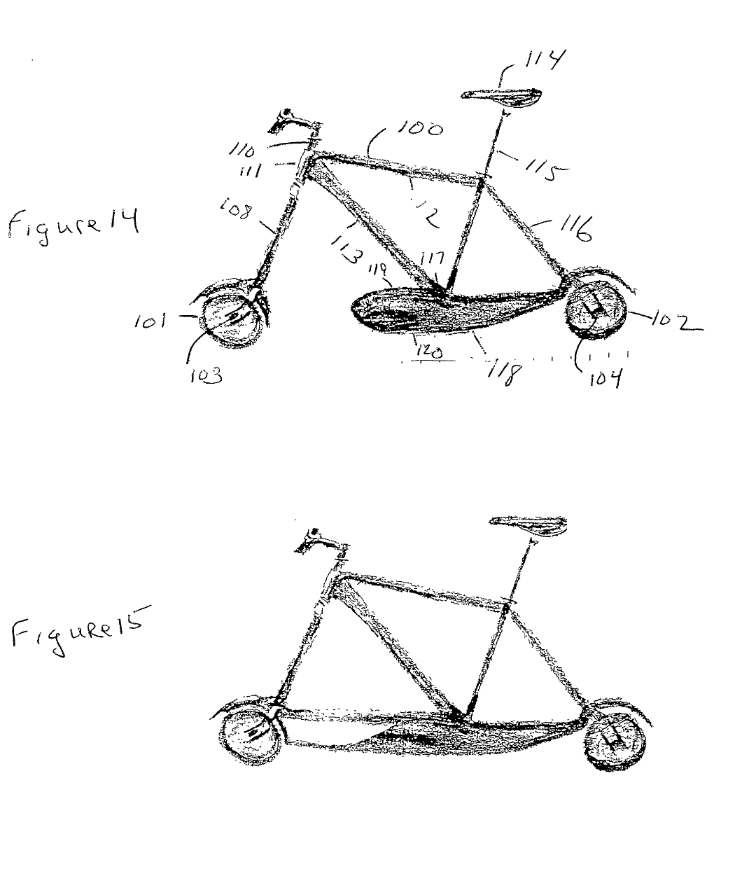

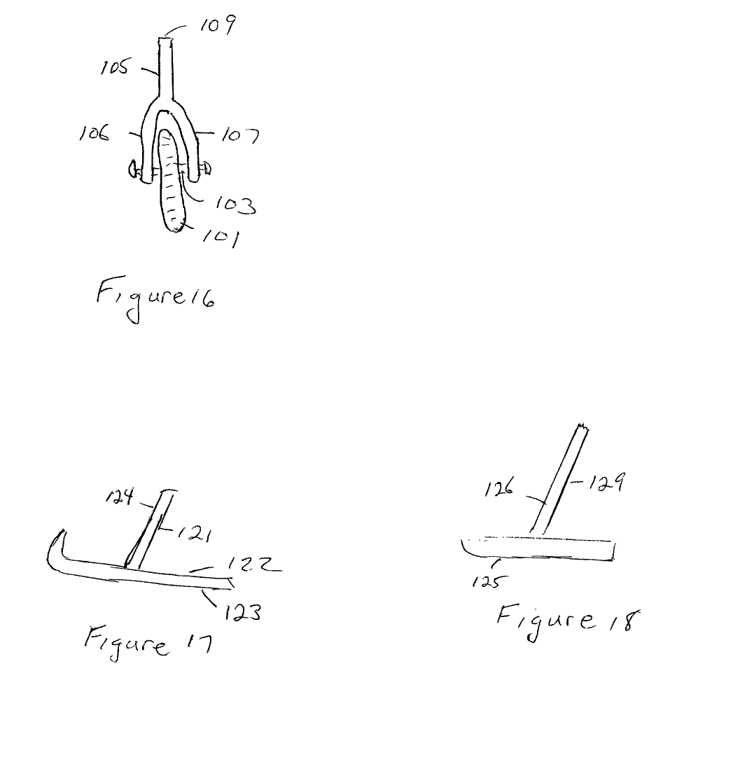

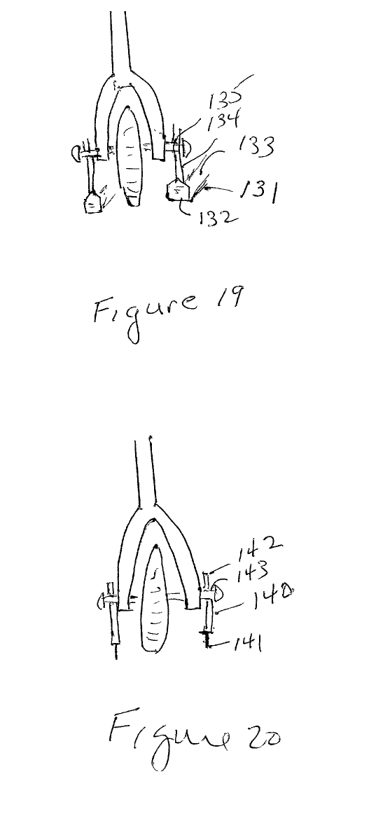

The rear wheel may have a similar arrangement as the front wheel as seen in FIG. 16. The fork of the rear wheel may be part of the rear support 116 as a single member or a separate member that is removably connected to the rear support 116. Removably connected to the bottom portion 117 of the frame 100 is a board 118. The board has a top surface 119 that connects to the frame and a generally flat bottom surface 120. The board may vary in width and is primarily to provide a rest area for the rider's feet during use of the scooter. The board is also advantageous when using the scooter in snow as the board assists the scooter pass through the snow.

One or both of the wheels of the scooter may be removed from the frame and replaced by a ski attachment. The ski attachment 121 has a ski 122 with a top surface and a bottom surface 123. The bottom surface is preferably generally smooth to facilitate travel over snow. The upper surface of the ski has a member 124 extending upwardly therefrom that may be received by the front support 108 in the same manner as the fork 105. Both the front wheel and the rear wheel may be replaced in this manner. If desired, both wheels may be removed and a single ski having a front member and a rear member on its upper surface may be attached to the frame in the same manner as the front and rear forks of the wheels. If a single ski is attached at both the front and rear of the scooter, the ski should preferably be in two sections, a front section and a rear section with at least the front section being pivotable about the rear section so that the single ski may be steered.

In an alternative embodiment the one or both of the wheels may be removed and replaced with an attachment 129 having a blade for traveling on ice. This attachment has a blade 125 on its lower surface. Extending from the upper surface is a member 126 that may be received by the front support 108 in the same manner as the fork 105. Both the front wheel and the rear wheel may be replaced in this manner.

In an additional embodiment the wheels on the scooter may remain in place on the frame. Attached to both or one side of the axle is a ski 131. The ski 131 has a bottom surface 132 and a top surface 133. extending from the top surface 133 of the ski is a member 134 that has an orifice 135 that the axle may pass through. A nut that is threaded onto the axle may be used to connect the ski member 134 to the scooter. The front wheel may have two of these skis on either side of the axle. Similarly, the rear wheel may also have one or both of these skis on either side of the axle.

There may also be a blade attachment similarly designed for attachment to the axle of the front and/or rear axle for use of the scooter on ice. The blade attachment 140 has a blade 141 on its bottom surface and a member 142 extending upwardly from the upper surface of the blade for connection to the axle by a suitable means such as an orifice 143.

The improved scooters of the present invention may be propelled by using the riders feet to push off the ground, by means of a pedal and chain arrangement as is common on bicycles or by means of a motor. As shown in the Figures the wheels present on the scooter are significantly smaller in diameter than the wheels typically seen on a bicycle. For example, the wheels for scooter are preferably less than 12″ in diameter, more preferably less than 8″ in diameter and most preferably less than 6″ in diameter.

The scooter with the ski or blade attachment may also be provided with an alternative braking means for slowing and stopping the scooter while it is traveling. One such braking means is a rotatable rod having one end extending downwardly and rearwardly from the scooter and a second end extending upwardly. The first end of the braking means may be provided with a tip that has a friction member such as a rubber tip for assisting in stopping. The first end of the braking means may be pushed downwardly by the second end of the braking means causing this end to be pressed into the snow or onto the ice causing the vehicle to slow and stop.

I claim:

1. An improved scooter comprising a base having a front wheel and a rear wheel that are rotatably connected to the base, said base having a steering means extending upwardly from the base and adapted to steer the front wheel, said base having an upper surface and a bottom surface, said lower surface having an attachment means for connecting a ski to the base said ski being comprised of a flat bottom surface and a front end and a rear end said ski having at said front end a lip to facilitate travel over snow.

2. The scooter according to claim 1 wherein said wheels have a surface that contacts a traveling surface and the bottom surface of the ski is in generally the same plane as the contact surface of the wheels.

3. The scooter according to claim 2 wherein the ski is connected to the underside of the base.

4. The scooter according to claim 2 wherein there are two skis connected to the base of the scooter.

5. The scooter according to claim 4 wherein the base has a skirt extending downwardly from the bottom surface of the base and the skis are connected to the base at the skirt.

6. The improved scooter according to claim 1 wherein the base has a seat on the upper surface thereof.

7. An improved scooter comprising a base having a front wheel and a rear wheel that are rotatably connected to the base, said base having a steering means extending upwardly from the base and adapted to steer the front wheel, said base having an upper surface and a bottom surface, said lower surface having an attachment means for connecting a runner to the base said runner having a blade on its surface opposite the base to facilitate travel over ice.

8. The scooter according to claim 7 wherein said wheels have a surface that contacts a traveling surface and the blade has a contact surface that is in generally the same plane as the contact surface of the wheels.

9. The scooter according to claim 8 wherein the ski is connected to the underside of the base.

10. The scooter according to claim 8 wherein there are two skis connected to the base of the scooter.

11. The scooter according to claim 10 wherein the base has a skirt extending downwardly from the bottom surface of the base and the skis are connected to the base at the skirt.

12. The improved scooter according to claim 7 wherein the base has a seat on the upper surface thereof.

13. A modular scooter kit comprising a scooter having a base having a front wheel and a rear wheel that are rotatably connected to the base, said base having a steering means extending upwardly from the base and adapted to steer the front wheel, said base having an upper surface and a bottom surface, said lower surface having an attachment means for connecting an attachment to the base to facilitate travel over snow or ice and wherein said attachment may be a ski or a runner.

14. An improved scooter comprising a frame having a front wheel and a rear wheel that are rotatably connected to the frame, said frame having a steering means extending upwardly from the front wheel and adapted to steer the front wheel, said front wheel rotating about an axle, said axle having connected thereto a ski having an upper surface and a lower surface, said ski having a member extending from said upper surface and connecting to said axle to permit the scooter to travel in snow.

15. The scooter according to claim 14 wherein said front wheel has a pair of skis connected to said axle.

16. The scooter according to claim 15 wherein said rear wheel rotates about an axle, said axle having connected thereto at least one ski having an upper surface and a lower surface, said ski having a member extending from said upper surface and connecting to said axle to permit the scooter to travel in snow.

17. An improved scooter comprising a frame having a front wheel and a rear wheel that are rotatably connected to the frame, said frame having a steering means extending upwardly from the front wheel and adapted to steer the front wheel, said front wheel rotating about an axle, said axle having connected thereto a blade having an upper surface and a lower surface, said blade having a member extending from said upper surface and connecting to said axle to permit the scooter to travel on ice.

15. The scooter according to claim 14 wherein said front wheel has a pair of blades connected to said axle.

16. The scooter according to claim 15 wherein said rear wheel rotates about an axle, said axle having connected thereto at least one blade having an upper surface and a lower surface, said blade having a member extending from said upper surface and connecting to said axle to permit the scooter to travel in snow.

17. An improved scooter comprising a frame having a front wheel and a rear wheel that are rotatably connected to the frame by means of a fork, said frame having a steering means extending upwardly from the front wheel and adapted to steer the front wheel, said front wheel rotating about an axle, said fork being removably connected to said frame and replaceable by a member having a first end and a second end, said first end being adapted to be connected to said frame in place of said fork and a ski attached to the second end.

18. The scooter according to claim 17 wherein the fork for the rear axle removably connected to said frame and replaceable by a member having a first end and a second end, said first end being adapted to be connected to said frame in place of said fork and a ski attached to the second end.

19. An improved scooter comprising a frame having a front wheel and a rear wheel that are rotatably connected to the frame by means of a fork, said frame having a steering means extending upwardly from the front wheel and adapted to steer the front wheel, said front wheel rotating about an axle, said fork being removably connected to said frame and replaceable by a member having a first end and a second end, said first end being adapted to be connected to said frame in place of said fork and a blade attached to the second end to permit the scooter to travel over ice.

20. The scooter according to claim 19 wherein the fork for the rear axle removably connected to said frame and replaceable by a member having a first end and a second end, said first end being adapted to be connected to said frame in place of said fork and a ski attached to the second end.
